(19) United States
(12) Patent Application Publication
(10) Pub. No.: US 2003/0167335 A1
(43) Pub. Date: Sep. 4, 2003

(54) System and method for network-based communication

(75) Inventor: Bruce Alexander, Poulsbo, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Vigilos, Inc.

(21) Appl. No.: 10/379,512

(22) Filed: Mar. 3, 2003

Related U.S. Application Data
(60) Provisional application No. 60/361,884, filed on Mar. 4, 2002.

(51) Int. Cl. G06F 15/16

(52) U.S. Cl. 709/228

(57) ABSTRACT

A system and method for providing two-way network based audio communications are provided. A number of client computers having input and output devices connect to one or more audio servers over a communications network. Users associated with the client computer can establish communication with an audio server and configure audio communications with input and output devices connected to the particular audio server. The connection with the audio server may be facilitated without requiring the initiating of the transmission of audio data between the audio server input and output devices and the client computer input and output devices. Further, client workstations can monitor, broadcast to, or engage in audio communication via the audio server.

### CROSS-REFERENCE TO RELATED APPLICATION

This application claims the benefit of U.S. Provisional Application No. 60/361,884, entitled SYSTEM AND METHOD FOR A NETWORK-BASED COMMUNICATION SYSTEM, and filed on Mar. 4, 2002. U.S. Provisional Application No. 60/361,884 is incorporated by reference herein.

### FIELD OF THE INVENTION

The present application relates generally to computer software, computer networks, and communication systems, and in particular, to a system and method for audio communication over a network.

### BACKGROUND OF THE INVENTION

Generally described, network-based software applications enable various types of one-to-many, many-to-many, or many-to-one communication between users of the network. Most typical software communication applications are predominantly textual, with electronic mail (“e-mail”) being the application with the greatest use. In contrast, as applied to audio communications, telephone communication systems provided by public switch telephone network (“PSTN”), or mobile telephone systems, provide the primary means for point-to-point audio communication.

A convergence of network-based software applications in telephonic, computer-enabled applications, such as voice over Internet protocol (“VoIP”) enable computer users to establish a link for the purpose of point-to-point audio communication over a computer network. VoIP can be used as an alternative to traditional telephone communication systems as applied for computer-to-computer, computer-to-telephone and telephone-to-telephone communication. However, telephony-based communications are limited by their reliance upon the initiation of an acceptance activity by the intended recipient prior to the delivery of audio data. For example, in a traditional PSTN-enabled telephone system, a call must be accepted or answered by a live recipient, recording device, or voice messaging service. This is also true of conventional VoIP applications where a receiver computer device initiates a responsive communication session as part of the exchange of any audio data.

Another type of audio communication system involves privately owned systems for facilitating two-way audio communication. These privately owned systems are generally referred to as “intercom systems.” Typically, a centralized broadcast site, or a “station,” generates messages that can be transmitted to a number of specified locations. Often, the specified locations, such as classroom within a building, are not operable to originate two-way communication, but can respond to a communication initiated by the central site. These intercom systems are typically configured and used exclusively within a local area network (“LAN”). For example, most intercom systems are limited to use within a particular geographic area, such as building or facility. However, these intercommunication systems are generally not configured to provide two-way audio communications over a wide area network (“WAN”), with multiple facilities having varied input and output devices, varied security access, and often varied owners.

Therefore, based on the above-described deficiencies associated with the conventional art, there is a need for a system and method for implementing a communication system that enables authorized users to configure and establish two-way audio communication over a wide area network.

### SUMMARY OF THE INVENTION

A system and method for providing two-way network based audio communications are provided. A number of client computers having input and output devices connect to one or more audio servers over a communications network. Users associated with the client computer can establish communication with an audio server and configure audio communications with input and output devices connected to the particular audio server. The connection with the audio server may be facilitated without requiring the initiating of the transmission of audio data between the audio server input and output devices and the client computer input and output devices. Further, client workstations can monitor, broadcast to, or engage in audio communication via the audio server.

In accordance with an aspect of the present invention, a method for facilitating networked-based communication is provided. The method may be implemented in a system including at least two computing devices connected via a communication device. In accordance with the method, an audio processing computing device obtains a request from a client computer. The request includes a configuration of input devices and output devices. The audio processing computing device transmits device state information corresponding to at least a portion of the selected input and output devices. Additionally, the audio processing computing device initiates the transmission of audio data between the configured input and output devices.

In accordance with another aspect of the present invention, a computer system for facilitating network-based communication is provided. The system includes a client computing device including at least one input device and output device. The system also includes an audio processing computing device including at least one input device and output device. The client computing device generates requests to configure at least one input device to an output device. The audio processing computing device configures the selected input and output devices. Further, the audio processing computing device initiates audio data transmission between the configured input and output devices.

In accordance with a further aspect of the present invention, a method for facilitating networked based communications is provided. The method may be implemented in a computing device including a graphical user interface and user manipulation device. In accordance with the method, a client computing device obtains a set of input devices and output devices available on a communication network. The client computing device generates a display corresponding to at least a subset of the input devices and output devices. The client computing device obtains a user selection of at least one device from the display. Additionally, the client computing device transmits the user selection in a request for audio device configuration to an audio processing computing device.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram representative of an Internet environment;

FIG. 2 is a block diagram illustrative of an audio communication system formed in accordance with the present invention;

FIG. 3 is a block diagram of an illustrative architecture for a client computer formed in accordance with the present invention;

FIG. 4 is a block diagram of an illustrative architecture for an audio server formed in accordance with the present invention;

FIG. 5 is the block diagram of FIG. 2 illustrating the connection of a client computer to an audio server in accordance with the present invention;

FIG. 6 is the block diagram of the audio communication system of FIG. 2 illustrating the transfer of device state and control settings between a client computer and an audio server in accordance with the present invention;

FIG. 7 is a block diagram of the audio communication system of FIG. 2 illustrating the initiating of an audio device and the transmission of audio data in accordance with the present invention;

FIG. 8 is a flow diagram of an audio connection processing routine implemented by an audio server formed in accordance with the present invention;

FIG. 9 is a block diagram of a screen display generated by a WWW browser for selecting one or more audio devices in accordance with the present invention; and

FIG. 10 is a flow diagram of an audio data processing subroutine implemented by an audio server formed in accordance with the present invention.

### DETAILED DESCRIPTION OF THE PREFERRED EMBODIMENT

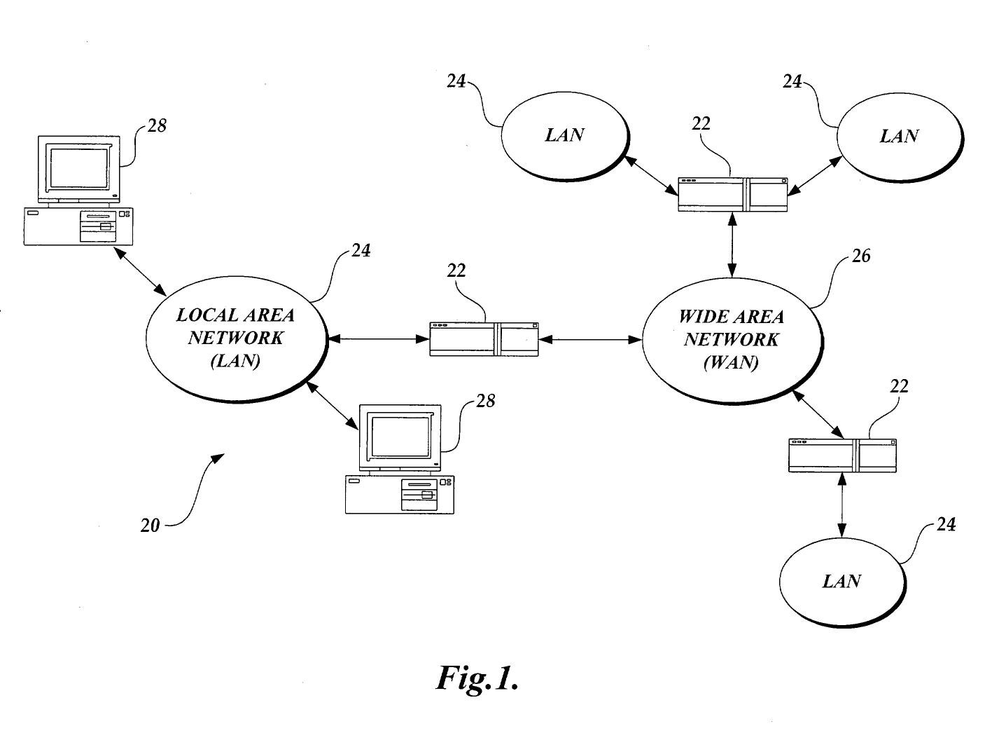

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers 28 and other related electronic devices can be remotely connected to either the LANs 24 or the WAN 26 via a digital communications device, modem and temporary telephone, or a wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive communication environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the Web server itself.

A remote access user may retrieve hypertext documents from the World Wide Web via a Web browser program. A web browser, such as Netscape's NAVIGATOR® or Microsoft's Internet Explorer, is a software application program for providing a user interface to the WWW. Upon request from the remote access user via the Web browser, the Web browser requests the desired hypertext document from the appropriate web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

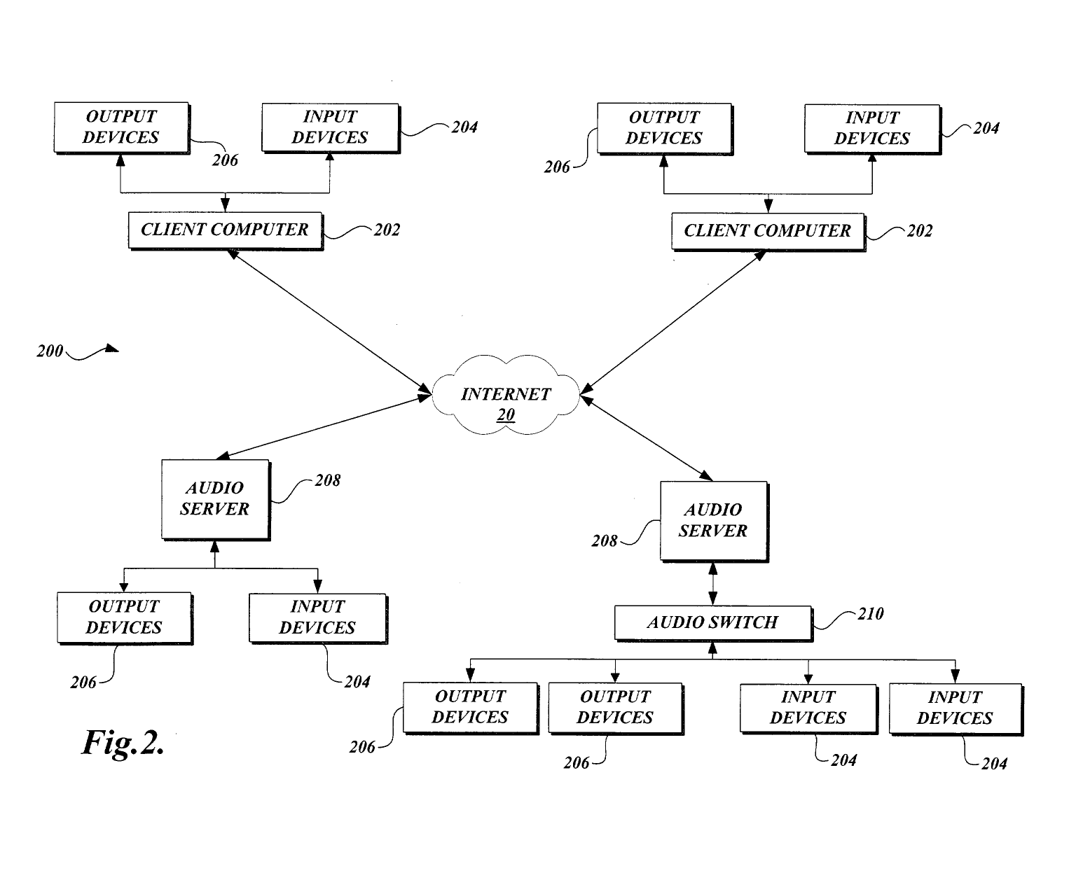

Referring now to FIG. 2, an actual embodiment of audio processing system 200 formed in accordance with the present invention will be described. In accordance with an illustrative embodiment of the present invention, the audio processing system 200 facilitates the transmission of audio data between a client computer 202 and an audio server 208. In accordance with an illustrative embodiment of the present invention, the audio processing system 200 may provide four modes of interaction. In one aspect, the client computer 202 can request and listen to recorded audio according to specific criteria. For example, the client computer 202 can request audio data corresponding to an origination or storage location, or a specified date, time period, or duration. In another aspect, the client computer 202 can request one-way live audio data from a specific location that would not activate audio output at the audio server 208. In a further aspect, the client computer 202 can broadcast live audio to a specific audio device on the audio server. Still further, the client computer 202 can initiate live two-way communication via the audio server 208. One skilled in the relevant art will appreciate that the audio system 200 may be configured to specifically provide a limited subset of the modes of interaction or that additional modes of interaction may be incorporated in the system. All are considered to be within the scope of the present invention.

As illustrated in FIG. 2, the client computers 202 can include a number of input devices 204 for receiving audio data and a number of output devices 206 for generating audio data. The input devices 204 can include devices for generating audible signals to users associated with the client computers 202, such as speakers, transmitters and the like, and devices for storing audio data for processing, mass storage devices, databases, and the like. Further, the input devices 204 can include software applications, and other processing components, to process incoming audio data or to convert other types of data into audio data. Output devices can include devices for encoding audible signals into electronic signals, analog microphones, digital microphones, instruments, and the like and devices that process pre-existing audio data, such as processors, mixers, filters, and the like. One skilled in the relevant art will appreciate that some of the input and output devices may be “on board” audio components integrated into client computer 202. For example, the client computer 202 may include one or more printed circuit boards that can process audio data. These printed circuit boards are often referred to as “sound cards.” Alternatively, some, or all, of the input and output devices may be external devices in communication with the client computer 202. The client computer 202 may communicate with the audio servers 208 via a global communication network, such as Internet 20, via private networks, or semi-private networks.

In one embodiment of the present invention, TCP/IP network sockets are utilized to communicate live audio. The client computer 202 can activate single, or multiple, one-way audio circuits via network sockets to exchange audio data with the audio server 208. In accordance with an embodiment utilizing two audio circuits, one audio circuit is reserved for receiving audio data (e.g., listening) and the other for transmitting audio data (e.g., speaking). Further, in another embodiment of the present invention, the client computer 202 may designate audio circuits to specific sources (e.g., microphones or areas) or to specific targets (e.g., person). In another embodiment of the present invention, some portion of the audio data, such as the recorded audio data, may be stored as audio files on the audio server and retrieved on demand. Accordingly, the client computer 202 can access the audio data using any standard data retrieval protocol, such as HTTP.

With continued reference to FIG. 2, the audio servers 208 may be server computing devices that include a number of input devices 204 and output devices 206. Similar to the client computer 202, some of the input and output devices may be “on board” audio components integrated into the audio server 208. For example, the client computer 202 may include one or more printed circuit boards that can process audio data. These printed circuit boards are often referred to as “sound cards.” Alternatively, some, or all, of the input and output devices may be external devices in communication with the client computer 202. As illustrated with audio server 208A, the audio server may facilitate communications with various input and output devices via an audio switch 210. One skilled in the relevant art will appreciate that an audio switch 210 is a hardware device operable to route incoming and outgoing audio data by filtering and forwarding audio data packets between segments of an audio network. The routing of inputs and outputs in an audio switch may be implemented via mechanical, electromechanical, and software controls. Similar to the client computer 202, the audio server 208, 208A can communicate via a global communication network, such as Internet 20, a private communication network and a semi-private communication network. Additionally, in an alternative embodiment of the present invention, at least some of the client computers 202 may serve the function of audio server 208 in a peer-to-peer network embodiment.

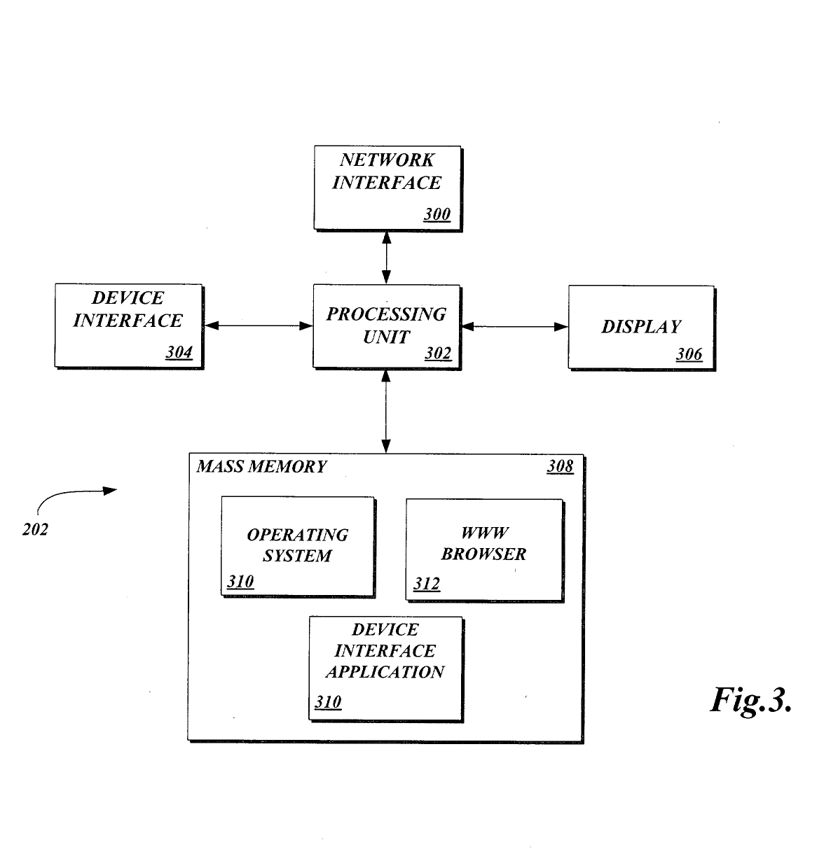

FIG. 3 depicts several of the key components of the client computer 202 (FIG. 2). Those of ordinary skill in the art will appreciate that the client computer includes many more components than those shown in FIG. 3. However, it is not necessary that all of these generally conventional components be shown in order to disclose an illustrative embodiment for practicing the present invention.

As shown in FIG. 3, the client computer may include a modem 300 for connecting to an Internet service provider through a point-to-point protocol (“PPP”) connection or a serial-line Internet protocol (“SLIP”) connection as known to those skilled in the art. The modem 300 may utilize a telephone link, cable link, wireless link, Digital Subscriber Line or other types of communication links known in the art. The client computer 202 may also include a network interface (not shown) for connecting directly to a LAN or a WAN, or for connecting remotely to a LAN or WAN. Those of ordinary skill in the art will appreciate that the modem 300, or network interface, includes the necessary circuitry for such a connection, and is also constructed for use with various communication protocols, such as the TCP/IP protocol, the Internet Inter-ORB Protocol (“IIOP”), X.25 and the like. The modem 300 may utilize the communication protocol of the particular network configuration of the LAN or WAN it is connecting to, and a particular type of coupling medium.

The client computer 202 also includes a processing unit 302, a device interface 304, a display 306, and a memory 308. The device interface 304 includes hardware and software components that facilitate interaction with a number of input devices 204 and output devices 206 via a variety of communication protocols, including, but not limited to, TCP/IP, X10, digital I/O, RS-232, RS-485, and the like. Additionally, the device interface 304 facilitates communication via a variety of communication mediums including telephone landlines, wireless networks (including cellular, digital, and radio networks), cable networks, and the like. The device interface 304 can also facilitate communication with one or more audio switches for connection to various input and output devices.

The memory 308 generally comprises a random access memory (“RAM”), a read-only memory (“ROM”), and a permanent mass storage device, such as a hard disk drive, tape driver, optical drive, floppy disk drive, CD-ROM, DVD-ROM, or removable storage drive. The memory 308 stores an operating system 310 for controlling the operation of the client computer 202. The memory 308 also includes a WWW browser 312, such as Netscape's NAVIGATOR® or Microsoft's INTERNET EXPLORER® browser, for accessing other components of the audio processing system 200 via the WWW. The client computer 202 can also include a device interface application 310 for facilitating communication with the input devices 204 and output devices 206.

It will be appreciated that these components may be stored on a computer-readable medium and loaded into memory 308 of the computing device using a drive mechanism associated with the computer-readable medium, such as a floppy disk drive, CD-ROM, DVD-ROM drive, or network interface 302. The memory 308, display 306, modem 300 and device interface 204 are all connected to the processor 302 via a bus. Other peripherals may also be connected to the processor in a similar manner. Additionally, one skilled in the relevant art will appreciate that the client computer 202 may be embodied in a variety of computing devices including desktop personal computers, server computers, hand-held computers, personal digital assistants, mobile communication devices, and the like. Still further, the client computer 202 may be embodied as a stand-alone computing device, or may be emulated in a general purpose-computing device.

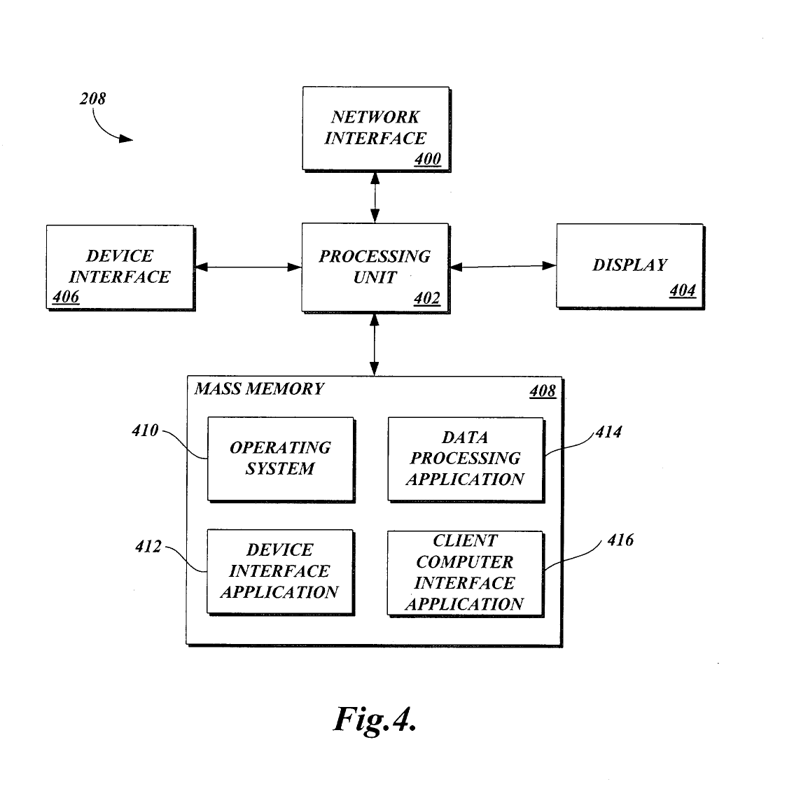

FIG. 4 is a block diagram depicting an illustrative architecture for an audio server 208 (FIG. 2). Those of ordinary skill in the art will appreciate that the audio server 208 includes many more components then those shown in FIG. 4. However, it is not necessary that all of these generally conventional components be shown in order to disclose an illustrative embodiment for practicing the present invention.

As shown in FIG. 4, the audio server 208 includes a network interface 400 for connecting directly to a LAN or a WAN, or for connecting remotely to a LAN or WAN. Those of ordinary skill in the art will appreciate that the network interface 400 includes the necessary circuitry for such a connection, and is also constructed for use with the TCP/IP protocol, the particular network configuration of the LAN or WAN it is connecting to, and a particular type of coupling medium. The audio server 208 may also be equipped with a modem for connecting to the Internet 20.

The audio server 208 also includes a processing unit 402, an optional display 404, a device interface 406 and a mass memory 408, all connected via a communication bus, or other communication device. The device interface 406 includes hardware and software components that facilitate interaction with a number of input and output devices via a variety of communication protocols, including, but not limited to, TCP/IP, X10, digital I/O, RS-232, RS-485, and the like. Additionally, the device interface 406 facilitates communication via a variety of communication mediums including telephone landlines, wireless networks (including cellular, digital, and radio networks), cable networks, and the like. As disclosed in FIG. 2, the device interface 406 may also communicate with one or more audio switches 206 for communication with individual input and output devices.

The mass memory 408 generally comprises a RAM, ROM, and a permanent mass storage device, such as a hard disk drive, tape drive, optical drive, floppy disk drive, or combination thereof. The mass memory 408 stores an operating system 608 for controlling the operation of the audio server 208. It will be appreciated that this component may comprise a general-purpose server operating system. The mass memory 408 also stores program code and data for interfacing with various input devices 204 and output devices 206 connected to the audio server 208, for processing incoming and outgoing audio data and for interfacing with one or more client computers 202. More specifically, the mass memory 408 stores a device interface application 412 in accordance with the present invention for facilitating the transfer of audio data between the audio server 208 and one or more client computers 202. The device interface application 412 comprises computer-executable instructions which, when executed by the audio server 208, interfaces with one or more input and output devices on a client computer 202 as will be explained below in greater detail.

The mass memory 408 also stores a data processing application 414 for configuring incoming and outgoing audio data. The operation of the data processing application 414 will be described in greater detail below. The mass memory 408 further stores a client computer interface application 416 for interfacing with one or more client computers 202 for configuring the transmission of audio data in accordance with the present invention. The operation of the client computer interface application 416 will be described in greater detail below. It will be appreciated that these software components may be stored on a computer-readable medium and loaded into the memory of the central server using a drive mechanism associated with the computer-readable medium.

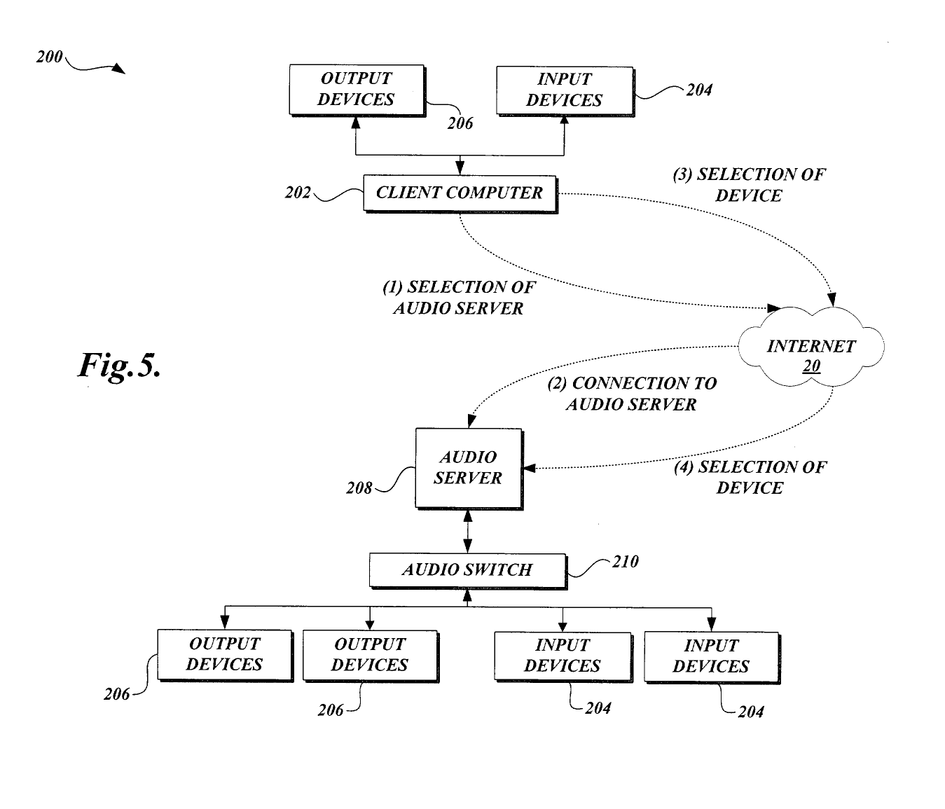

Generally described, the present invention provides a system and method for facilitating two-way audio transmissions between client computers 202 and audio servers 208 in a wide area network environment. In an illustrative embodiment of the present invention, the audio processing system 200 configures two-way communication channels between client computers 202 and audio servers 208 and allows for customized configuration of specific input devices 204 to output devices 206. FIGS. 5-8 are block diagrams illustrative of the audio processing system 200 of FIG. 2 illustrating the initiation of a two-communication channel, the configuration of input and output devices on the two-ways communication channel and the transmission of audio data between the two-way communication channel. One skilled in the relevant art will appreciate that the disclosed embodiments are illustrative in nature and should not be construed as limiting.

With reference to FIG. 5, two-way communication may be initiated by the selection of an audio server 208 by the client computer 202. In an illustrative embodiment of the present invention, communication may be initiated by the WWW browser 312 of the client computer 202. Each audio server 208 may correspond to a unique Internet Protocol (“IP”) address directly addressable by the client computer 202. Alternatively, the WWW browser 312 may contact an entry IP address and be redirected to a particular IP address. For example, a load balancing component on a Web server may select from a redirect IP address from a group of audio servers 208 based upon current server utilization. The connection with the audio server 208 may utilize security protocols such as the secure sockets layer (“SSL”) encryption protocol.

Once a connection has been established, the client computer 202 may configure the transmission of audio data between one or more input and output devices. In an illustrative embodiment of the present invention, a user at the client computer 202 may manipulate a graphical user interface to configure one or more input devices 204 to a one or more output devices 206. For example, the user interface may generate a display corresponding to a matrix that allows a user to configure one or more input devices 204 to one or more output devices 206 by manipulating the matrix. Further, in another illustrative embodiment of the present invention, the client computer 202 may be configured with one or more predetermined input device/output device configurations that be automatically transmitted or manually selected by a user.

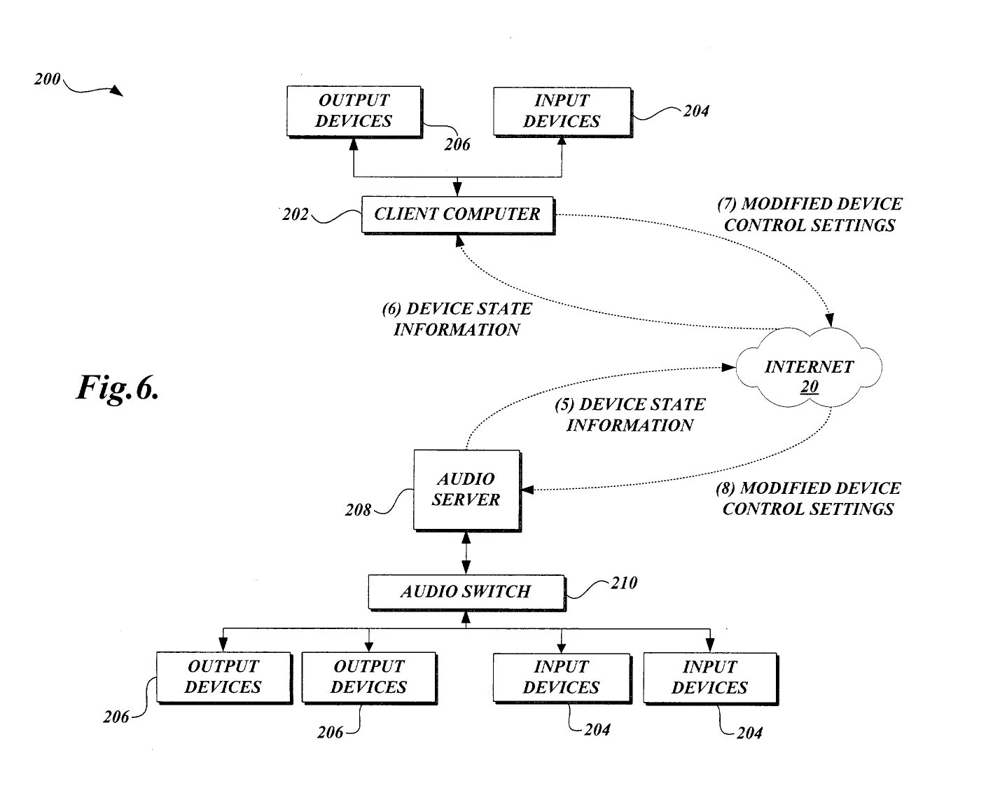

With reference now to FIG. 6, once the audio server 208 and corresponding audio devices have been selected, the audio server transmits device state information to the client computer 202. In an illustrative embodiment of the present invention, device state information can include the status of various attributes, or parameters, associated with the particular devices (e.g., on, off, standby). The device state information can also include setting information, such as volume levels, resolution levels, data transmission types, and the like. Based on the device state information, the client computer 202 may transmit modified control settings to set up particular devices for audio transmission. Additionally, in one embodiment of the present invention, the client computer 202 may have pre-determined configuration settings that can be automatically transmitted to the audio server 208 for modification of various selected audio devices. As illustrated in FIG. 6, in an actual embodiment of the present invention, the client computer 202 is in communication with the audio server 208 prior to the transmission of the audio data between the selected devices. One skilled in the relevant art will appreciate that the transmission of additional configuration settings illustrated in FIG. 6 may be omitted.

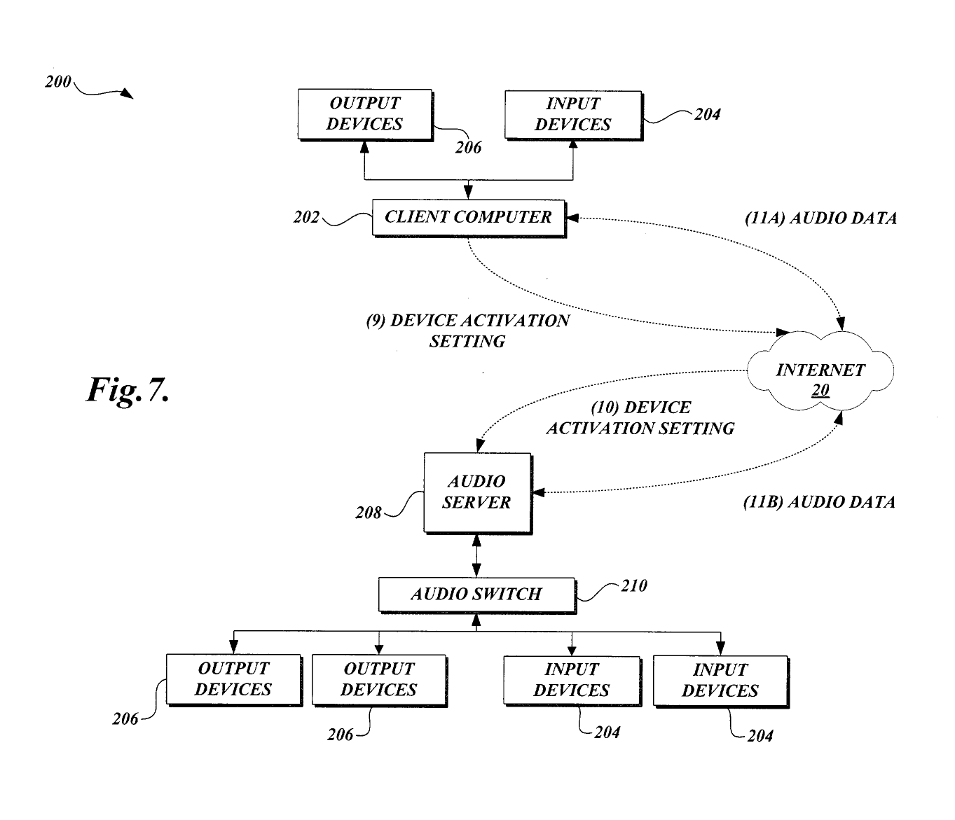

With reference now to FIG. 7, once the audio devices have been set for transmission, the client computer 202 may initiate the transmission of audio data. In one embodiment of the present invention, a user at the client computer 202 may manipulate a graphical user interface to initiate the audio transmission. Alternatively, the client computer 202 may initiate the audio transmission automatically without requiring additional user interaction. In one aspect, the client computer 202 may initiate the transmission of audio data by transmitting audio data to the audio server 208. Additionally, the client computer 202 may transmit an explicit request to receive audio data from the audio server. As illustrated in FIG. 7, the audio transmission may be two-way audio transmission. Accordingly, both the client computer 202 and the audio server 208 may transmit and receive audio data across the communication network.

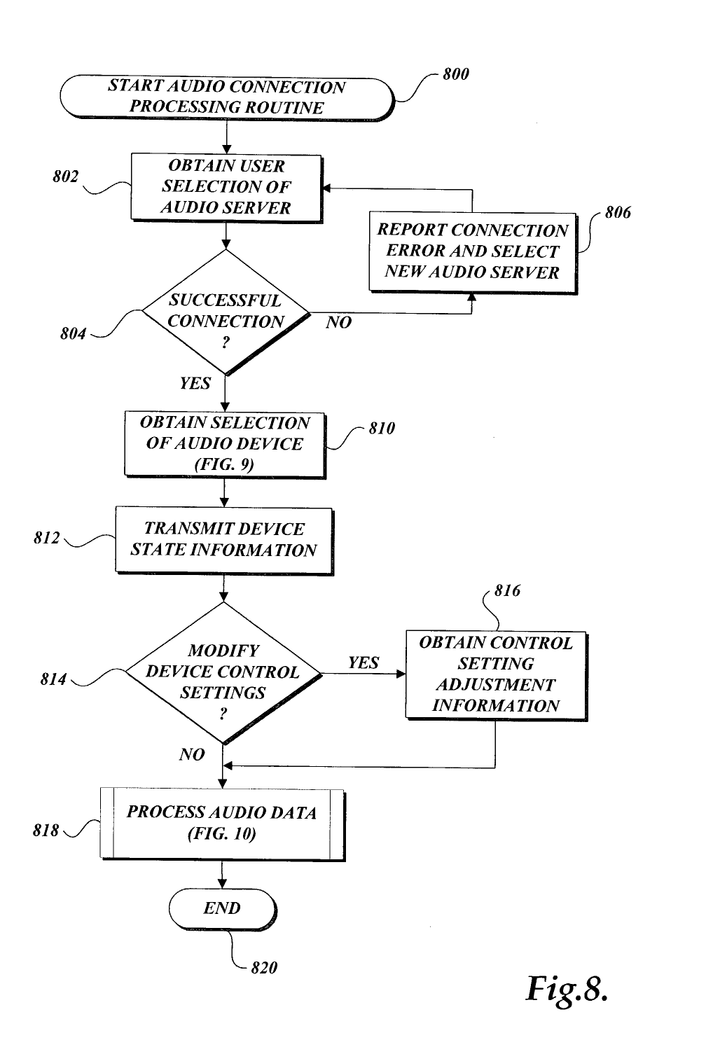

With reference now to FIG. 8, a routine 800 implemented by the audio server 208 for processing an audio connection will be described. Although FIG. 8 will described in terms of the audio server 208, one skilled in the relevant art will appreciate that a client computer 202 configured in a peer-to-peer network may implement routine 800. At block 802, the client computer interface 416 obtains a selection of an audio server 208. As described above, the client computer 202 may select an audio server by directly addressing the logical address of the audio server 208, such as an IP address. Alternatively, the client computer 202 may access a general audio transmission Web site, or IP address, and be redirected to a selected audio server 208. At decision block 804, a test is conducted to determine whether the audio connection to determine whether the connection is successful. If the connection is not successful, at block 806, an error report is reported and the client computer 202 may be prompted to select a new audio server.

As described above, in one embodiment of the present invention, the client computer 202 connects to the audio server 208 using TCP/IP sockets. For transmission of audio data, audio is received by a local or remote input device connected to the client computer 202 and transmitted via the network to a designated audio server 208. The audio data is received by an audio card on the audio server 208 and can be further processed. For receipt of audio, audio is collected by the audio card on the audio server 208 and forwarded to the client computer's 208 audio card as output. The audio server 208 stores the TCP/IP socket data used to transmit and receive audio in a database associated with the audio server 208. In a further embodiment, if the audio server 208 is operable to communicate with more than one audio card, each audio card will have a unique port for receipt and transmission. Additionally, in an actual embodiment of the present invention, the client computer 202 and the audio server 208 may also initiate security protocols, such as SSL. Still further, the client computer 202 and the audio server 208 may maintain continuous data transmission links, such as virtual private network (“VPN”).

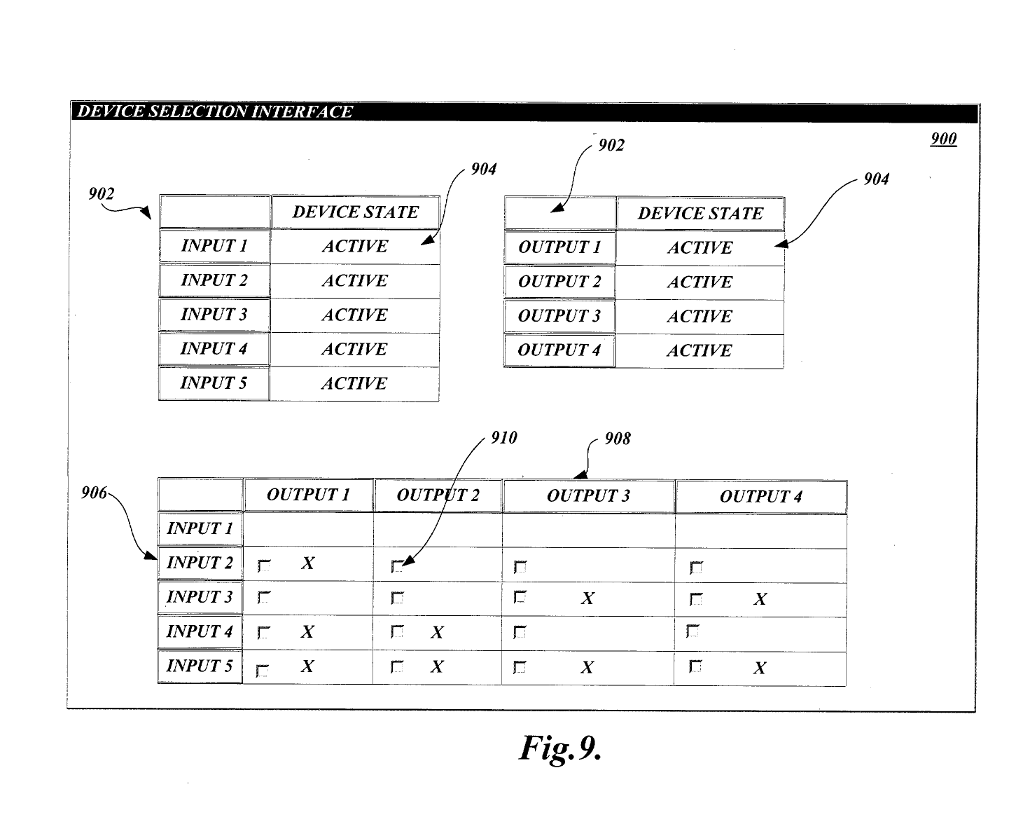

If the connection is successful, at block 810, the client computer interface 416 obtains a selection of audio devices connected to the audio server 208. In one embodiment of the present invention, the user may select an audio device such as an audio card and specify parameters for the retrieval of audio. For example, the user may specify a start date, start time, and a duration-or specified time interval. At block 812, the client computer interface 416 transmits the device state information to the client computer 202. With reference now to FIG. 9, a block diagram illustrative of a screen display 900 for selecting and configuring audio devices in accordance with the present invention. The screen display 900 includes a section 902 for displaying various settings for input devices 204. In an illustrative embodiment of the present invention, the section 902 may list a device state 904 for all input devices 204 and output devices 206 on both the client computer 202 and the audio server 208. The screen display 900 also includes a section 906 for configuring input devices 204 and output devices 206. As illustrated in FIG. 9, a table 908 may be utilized in accordance with the present invention with all available input devices 204 in one column and all available output devices 206 in one row. To configure the devices, a user may manipulate the screen display 900 by indicating which input device 204 should be connected to which output device 206. In an illustrative embodiment of the present invention, the user may be presented with check boxes 910 for manipulation. One skilled in the relevant art will appreciate that alternative screen displays, or other user interfaces, may be utilized in accordance with the present invention. Further, as described above, a user may store and recall a number of device configurations for automatic configuration of input devices and output devices.

Returning back to FIG. 8, at decision block 814, a test is conducted to determine whether the client computer 202 indicates that control settings should be modified. If the control setting should be modified, at block 816, the client computer interface 416 obtains control setting information from the client computer 202. As discussed above, in one embodiment, the client computer may be presented with a user interface for adjusting various parameters associated with audio devices connected to the audio server 208. The various parameters include, but are not limited to, volume, resolution, encoding format, filtering information and the like. In another embodiment, the client computer 202 may be configured to automatically send adjustment information based on pre-determined settings. In an alternative embodiment, the audio server 208 may store client computer 202 audio device parameters and implement the settings upon connection to the client computer 202. In still another embodiment of the present invention, a client computer 202 may have multiple device parameters depending on a condition, indication of an alarm, time of day, presence of an identifiable individual, and the like. If the device control settings are not adjusted at decision block 814, or once the device control settings are adjusted at block 816, the audio server 208 processes the transmission of audio data at block 818. A subroutine 1000 for processing audio data will be described below. At block 820, the routine 800 terminates.

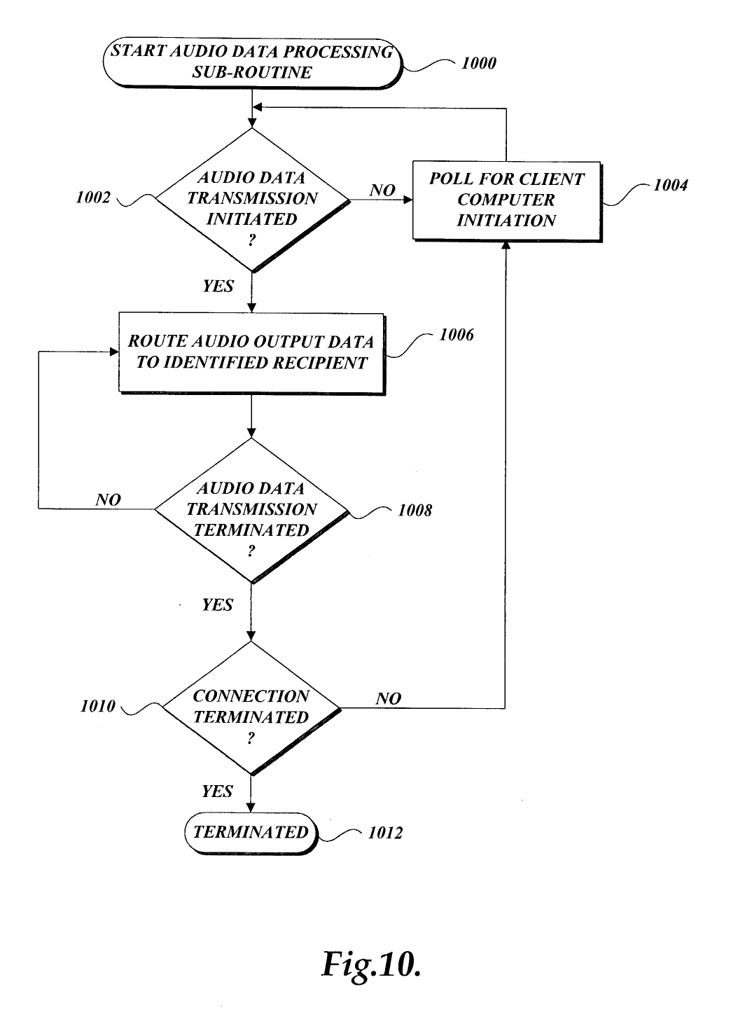

With reference now to FIG. 10, a sub-routine 1000 implemented by the audio server 208 for processing the transmission of audio data (block 818) will be described. In a manner similar to routine 800, although FIG. 10 will described in terms of the audio server 208, one skilled in the relevant art will appreciate that a client computer 202 configured in a peer-to-peer network may implement routine 1000. At decision block 1002, a test is conducted to determine whether audio transmission has been initiated. If audio transmission has not been initiated, at block 1004, the client computer interface 416 polls for a client computer 202 initiation of audio transmission. In one embodiment of the present invention, the client computer 202 may initiate communications by transmitting audio data. Additionally, the client computer 202 and audio server 208 may initiate communication (FIG. 8) without transmitting audio data. In this embodiment, the client computer 202 and the audio server 208 may first establish a communication channel. Further, in another embodiment, the client computer may initiate communication by transmitting a request to receive audio data. This embodiment may be applicable in both a one-way and two-way communication model.

Once the client computer 202 has initiated audio communication, at block 1006, the device interface application 412 routes audio output data from selected output devices 206 to one or more identified input devices 204. In accordance with the present invention, audio communication between the audio server 208 and the client computer 202 can be two-way communication. Accordingly, based on the configuration of audio devices (block 810, FIG. 8), the device interface application 412 routes the audio transmissions accordingly. In one aspect of the present invention, the audio server 208 can transmit live audio data directly to the client computer 202, or with relatively small delay. In another aspect of the present invention, the audio server 208 can store incoming audio card data as a file on the audio server 208. The audio file, known as a spool, can be indexed using a variety of attributes, such as a Universal Time Code value. For a continuous data gathering embodiment, at a specified termination point (such as midnight), the current audio spool is closed and a new spool is opened as a different file. Accordingly, when the audio server 208 receives a request for audio data, it locates the appropriate spool and extracts the data. This is accomplished by locating the applicable spool and calculating the displacement into the audio data based on the difference between the spool start and the requested start time. Data identified by the displacement calculation is extracted from the file. The extracted data is stored in a temporary spool file with a new audio header. The temporary spool file name is returned to the client computer 202 which uses that file name to retrieve the recorded audio via HTTP. At decision block 1008, a test is conducted to determine whether the audio data transmission has been terminated. If the audio transmission has not been terminated, the sub-routine 1000 returns to block 1006, where the device interface application 412 continues to route audio data. If the audio transmission has been terminated, at decision block 1010, a test is conducted to determine whether the connection with the audio server 208 has been terminated. If the connection has not been terminated, the sub-routine 1000 returns to block 1004 to poll for the initiation of audio transmission by the client computer 202. If the connection has been terminated, the sub-routine 1000 terminates and returns to routine 800.

In accordance with the system and method of the present invention, two-way audio communication is enabled between client computers 202 and audio servers 208. The system 200 may be incorporated into other monitoring or communications systems, such as security monitoring networks, communication networks, and the like. In one embodiment of the present invention, a system administrator at the audio server 208 may initiate an “intercom” mode in which an input device 204 at the audio server transmits to all the client computer output devices 206. In another embodiment of the present invention, a user at a client computer 202 may change the configuration, such as through screen display 900 (FIG. 9), throughout a communication session.

In another embodiment of the present invention, users at a client computer 202 may configure input devices 204 and output devices 206 to create audio “zones” within a given area. For example, the audio server 208 may correspond to a facility being monitored such that the client computer can monitor and communicate with defined areas, or zones, within the premises. In still another embodiment of the present invention, an audio server 208 may obtain audio information from another audio server 208 and transmit the audio data to the client computer 202.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In a system including at least two computing devices connected via a communication device, a method for facilitating networked-based communication, the method comprising:
obtaining a request from a client computer, the request including a configuration of input devices and output devices;
transmitting device state information corresponding to at least a portion of the selected input and output devices;
initiating the transmission of audio data between the configured input and output devices.

2. The method as recited in claim 1, wherein the configuration of input devices and output devices includes a configuration of an output device on the client computer.

3. The method as recited in claim 1, wherein the configuration of input and output devices includes a configuration of an input device on the client computer.

4. The method as recited in claim 1, wherein the configuration of input and output devices includes a configuration of an input device and an output device on the client computer.

5. The method as recited in claim 1 further comprising configuring the input and output devices according to the configuration information, wherein configuring the input and output devices includes establishing at least one TCP/IP socket for communication.

6. The method as recited in claim 5, wherein configuring the input and output devices includes establishing a plurality of TCP/IP sockets corresponding to a designated number of communication links.

7. The method as recited in claim 1 further comprising obtaining a request to modify device state information for at least one configured device and modifying the device in accordance with the request.

8. The method as recited in claim 7, wherein the device state information is selected from a group consisting of status of a device, volume setting, resolution setting, and data transmission type.

9. The method as recited in claim 1, wherein the request for configuration of input devices and output devices includes one or more parameters for transmitting audio data.

10. The method as recited in claim 9, wherein the one or more parameters include time-based criteria.

11. The method as recited in claim 1 further comprising generating a user interface corresponding to potential configurations for input and output devices and transmitting the user interface to the client computer.

12. The method as recited in claim 1, wherein initiating the transmission of audio data between the configured input and output devices includes obtaining incoming audio data from the client computer.

13. The method as recited in claim 1 wherein initiating the transmission of audio data between the configured input and output devices includes obtaining a request for audio data from the client computer.

14. The method as recited in claim 1, wherein initiating the transmission of audio data between the configured input and output devices includes transmitting audio data to the client computer.

15. The method as recited in claim 1, wherein initiating the transmission of audio data between the configured input and output devices includes transmitting audio data to the client computer and obtaining audio data from the client computer.

16. The method as recited in claim 1, wherein initiating the transmission of audio data between the configured input and output devices includes transmitting live audio data to the client computer.

17. The method as recited in claim 1, wherein initiating the transmission of audio data between the configured input and output devices includes transmitting stored data to the client computer.

18. The method as recited in claim 17, wherein transmitting stored data includes:
obtaining incoming live data from an output device;
storing the incoming live data in a data file, wherein the data file is indexed according to a time parameter;
obtaining a request for stored data, the request including time criteria;
determining a time offset from the index of the data file;
transmitting a subset of the audio of the data file corresponding to the offset.

19. A computer-readable medium having computer-executable instructions for performing the method recited in claim 1.

20. A computer system including a processor, a memory and an operating environment, the computer system operable to perform the method as recited in claim 1.

21. A computer system for facilitating network-based communication, the computer system comprising:
a client computing device including at least one input device and output device; and
an audio processing computing device including at least one input device and output device;
wherein the client computing device generates requests to configure at least one input device to an output device;
wherein the audio processing computing device configures the selected input and output devices; and
wherein the audio processing computing device initiates audio data transmission between the configured input and output devices.

22. The system as recited in claim 21, wherein the configuration of input devices and output devices includes a configuration of an output device on the client computer.

23. The system as recited in claim 21, wherein the configuration of input and output devices includes a configuration of an input device on the client computer.

24. The system as recited in claim 21, wherein the configuration of input and output devices includes a configuration of an input device and an output device on the client computer.

25. The system as recited in claim 21, wherein the audio processing computing device configures at least one TCP/IP socket for communication with the client computing device.

26. The system as recited in claim 25, wherein the audio processing computing device configures a plurality of TCP/IP sockets corresponding to a designated number of communication links between the client computer and the audio processing computing device.

27. The system as recited in claim 21, wherein the audio processing computing device transmits device state information corresponding to at least a portion of the selected input and output devices.

28. The system as recited in claim 27, wherein the client computer transmits a request to modify at least one parameter associated with a configured device.

29. The system as recited in claim 27, wherein the device state information is selected from a group consisting of status of a device, volume setting, resolution setting, and data transmission type.

30. The system as recited in claim 21, wherein the audio processing computing device initiates transmission of audio data between the configured input and output devices by receiving incoming audio data from the client computer.

31. The system as recited in claim 21 wherein the audio processing computing device initiates transmission of audio data between the configured input and output devices by obtaining a request for audio data from the client computer.

32. The system as recited in claim 21, wherein the audio processing computing device initiates transmission of audio data between the configured input and output devices by transmitting audio data to the client computer.

33. The system as recited in claim 21, wherein the audio processing computing device initiates transmission of audio data between the configured input and output devices by transmitting audio data to the client computer and obtaining audio data from the client computer.

34. The system as recited in claim 21, wherein initiating the transmission of audio data between the configured input and output devices includes transmitting live audio data to the client computer.

35. The system as recited in claim 21, wherein the audio processing computing device initiates transmission of audio data between the configured input and output devices by transmitting stored data to the client computer.

36. The system as recited in claim 35, wherein the audio processing computing device is further operable to obtain obtaining incoming live data from an output device, store the incoming live data in a data file according to a time parameter.

37. The system as recited in claim 36, wherein the audio processing computing device is further operable to obtain obtaining a request for stored data including time criteria, determine a time offset from the index of the data file, and transmit a subset of the audio of the data file corresponding to the offset.

38. The system as recited in claim 21, wherein the audio processing computing device is a server computing device.

39. The system as recited in claim 21, wherein the audio processing computing device is a client computing device.

40. The system as recited in claim 21, wherein the audio processing device terminates audio transmission, while maintaining a communication link with the client computing device.

41. In a computing device including a graphical user interface and user manipulation device, a method for facilitating networked based communications, the method comprising:
obtaining a set of input devices and output devices available on a communication network;
generating a display corresponding to at least a subset of the input devices and output devices;
obtaining a user selection of at least one device from the display; and
transmitting the user selection in a request for audio device configuration to an audio processing computing device.

42. The method as recited in claim 41, wherein at least one input device corresponds to the computing device.

43. The method as recited in claim 41, wherein at least one output device corresponds to the computing device.

44. The method as recited in claim 41 further comprising obtaining at least one stored selection of devices and automatically selecting corresponding devices on the display.

45. The method as recited in claim 41 further comprising obtaining device state information corresponding to at least one selected device and displaying the device state information on the display.

46. The method as recited in claim 45 further comprising obtaining a modification of at least one device parameter corresponding to the device state information and transmitting the modification of the at least one device parameter to the audio processing computing device.

47. The method as recited in claim 46 further comprising obtaining at least one stored modification of device parameters from the display and automatically transmitting the modification to the audio processing computing device.

48. The method as recited in claim 41 further comprising transmitting audio data to the audio processing computing device to initiate communication.

49. The method as recited in claim 41 further comprising transmitting a request for audio data to the audio processing computing device to initiate communication.

50. The method as recited in claim 41 further comprising obtaining a request to terminate audio transmission and transmitting the request to the audio processing computing device.

51. A computer-readable medium having computer-executable instructions for performing the method recited in claim 41.

52. A computer system including a processor, a memory and an operating environment, the computer system operable to perform the method as recited in claim 41.
